(19) United States
(12) Patent Application Publication
(10) Pub. No.: US 2008/0040213 A1
(43) Pub. Date: Feb. 14, 2008

(54) System and method of distributing product samples with feedback

(76) Inventors: Brian Leibowitz, Huntington, NY (US); James Salerno, Huntington Station, NY (US)

Correspondence Address: Howard C. Miskin, Esq.;Stoli, Miskin & Badie, Suite 4710, 350 Fifth Avenue, New York, NY, 10118, US

(21) Appl. No.: 11/500,819

(22) Filed: Aug. 8, 2006

(51) Int. Cl. G06Q 30/00

(52) U.S. Cl. 705/14

(57) ABSTRACT

A method and marketing system that allows for the distribution of product samples to a manufacturer's target audience and provides the manufacturer with consumer information. The two main participants of the system are manufacturers and consumers. Consumers provide information to a membership database. Manufacturers provide product samples to onsite locations and thereby create a manufacturers database. Products are provided to the onsite locations for sampling. Consumers may decide which product to sample. Once a product is taken by a consumer the system sends the consumer information into the manufacturer's database. The manufacturer is then provided with access to view the consumer information regarding its sample products. Once the manufacturer has this information it is free to contact consumers regarding the product sampled, send the consumer a survey, coupons, or more products.

### FIELD OF THE INVENTION

The invention relates to a marketing system and method of distributing product samples. In particular, an improved marketing system that allows customers to easily choose and obtain product samples and provides customer feedback and information to manufacturers for further marketing purposes. This advantageously allows efficient sampling of products and access to target consumer data.

### BACKGROUND OF THE INVENTION

Manufacturers benefit from consumers' sampling of their new and/or improved products. Free product sampling enables manufacturers to generate repeat usage, have access to their target consumers, and receive consumer feedback. Free product sampling is a common method to support the launch of a new product.

Often the key to product sampling is locating the target audience. Many different prior art methods are used to locate the target audience of products. Many times manufacturers base their target audience on consumers' prior consumption and use of similar items by creating groups of potential purchasers for the receipt of a target article from a database collected from the earlier distribution of similar items. Another method of locating a manufacturer's target audience is to randomly collect personal information and distribute the samples based on personal attributes of the consumer, such as self-identified interests, age, sex, occupation, and geographic location. Other methods include random direct mailing, door-to-door, in-store distribution and delivery in newspaper sections.

In the prior art method, a sample product is often distributed to consumers with information for the consumer to unilaterally contact the manufacturer, for either additional samples or coupons to purchase the sampled products at a discount. The manufacturer normally requires basic information from the consumer before providing either the additional sample or coupons. Such consumer data is then stored in a database for future marketing purposes.

There are many drawbacks and limitations to the prior art methods used for product sampling. The methods discussed above merely guess at a consumer's interest in a product sample and often product samples are distributed to consumers who are not interested in the product. This is a waste of the manufacturers' time, money and effort. Additionally, money and resources are wasted on the cost of traditional packing and delivery methods. Further, manufacturers are not able to receive the consumer feedback on the products they distribute if the consumer fails to contact the manufacturer for additional samples or coupons.

Therefore, there is a need for a marketing system and method of efficiently distributing product samples to obtain relevant consumer data and feedback.

### SUMMARY OF THE INVENTION

The present invention provides a method and marketing system that allows for the efficient distribution of product samples and automatically provides the manufacturer with consumer information.

The method and marketing system of the present invention, in particular, is one or more sampling centers or onsite locations with an electronic network that allows consumer selection of sample products, while instantaneously providing manufacturers with such consumer's information.

The method and marketing system of the present invention involves and links the two groups of participants: manufacturers and consumers. The product sampling system provides a membership module that collects and stores consumer information into a consumer membership database. Once a consumer has provided contact information and other preferences, he/she is provided with a membership card and unique identification number. The membership module is available for access on the Internet, other electronic means, or at on-site locations. Manufacturers may register to participate in the product sampling system via the membership module. The membership module further collects and stores manufacturer information into a manufacturer membership database. Once registered, manufacturers are given a unique member identification number and password to access the product database associated with their products.

Manufacturers provide product samples and print media to onsite locations. When a manufacturer provides a product for sampling, a product database is created for that product. The product database is linked to the particular manufacturer who provided the product samples. The onsite locations are chosen to be high foot traffic areas, such as a mall, airport, mass transit hub, sports stadium, or casino. The onsite location may consist of a kiosk system, a storefront, or Internet website.

In one embodiment, a kiosk is set up to display eight (8) products available for sampling along with the manufacturer's print media pertaining to the samples provided. A consumer may go to an onsite location and view the products available for sampling. Each product at the onsite location is assigned an identification number. When a consumer sees a product they want to sample he/she scans his/her membership card at a reader that is associated with that product. The consumer is then able to obtain one of the selected products to sample. Each consumer is allowed to sample one of each product per day. Once a consumer's membership card is read, such consumer information is automatically transferred to the product database along with the onsite location, date and time of the sampling. A manufacturer is then able to access its product database with its member identification number and password. The manufacturer obtains valuable information about each consumer who samples its product. This provides the manufacturer with contact information of relevant consumers for feedback, product surveys, additional distribution of product samples, coupons, etc.

### BRIEF DESCRIPTION OF THE DRAWINGS

A preferred embodiment of the present invention has been chosen for purposes of illustration and description and is shown in the accompanying drawings forming a part of the specification wherein:

FIG. 1 illustrates the overall environment for the method and system of the present invention.

FIG. 2 illustrates the membership module of the present invention.

FIG. 3 illustrates the environment concerning the membership module of the present invention.

FIG. 4 illustrates examples of consumer information concerning the present invention.

FIG. 5 illustrates the sequence of events that occurs when a consumer samples a product of the present invention.

FIG. 6 illustrates the product database of the present invention.

FIG. 7 illustrates the product databases of the present invention.

### DETAILED DESCRIPTION OF THE PREFERRED EMBODIMENTS

The method and system of the present invention will be described with reference to the drawings.

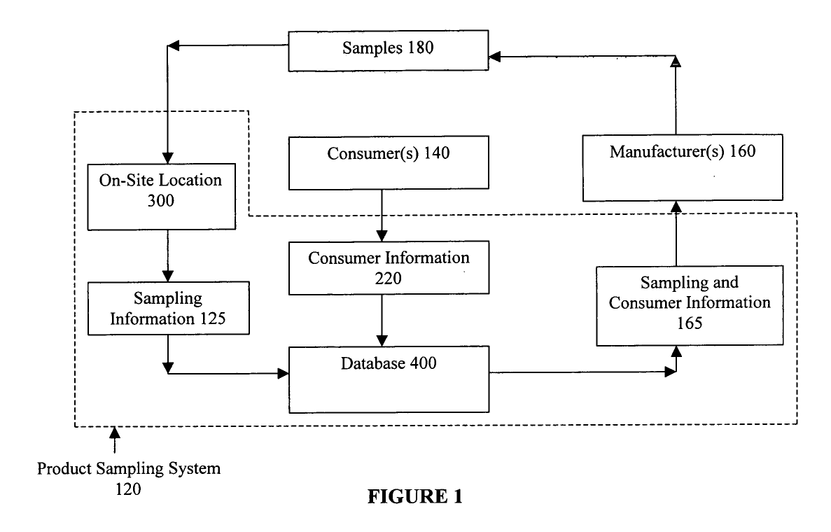

FIG. 1 illustrates the overall environment 100 where the present invention may be utilized. The overall environment 100 involves two groups of participants: one or more consumers 140 and one or more manufacturers 160. The product sampling system 120 of the present invention links the consumers 140 with the manufacturers 160. The product sampling system 120 collects and stores consumer information 220 and selectively provides it to manufacturers 160 through a database 400 accessible via an electronic network such as the internet.

As shown in FIG. 1, consumers 140 provide personal information or consumer information 220 to be stored in the database 400. Manufacturers provide samples 180 and product print material to the product sampling system 120. The samples 180 are offered at one or more onsite locations 300, such as malls, to consumers 140. Consumers 140 obtain the samples 180 through the product sampling system 120 at an on-site location 300. The product sampling information 125 is provided to the database 400. Manufacturers 160 can access the database 400 with the product sampling information 125 and relevant consumer information 120 pertaining to their specific product samples 180 provided to the product sampling system 120.

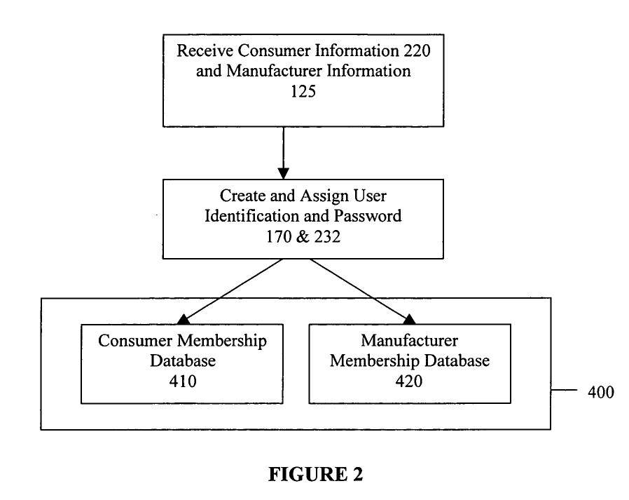

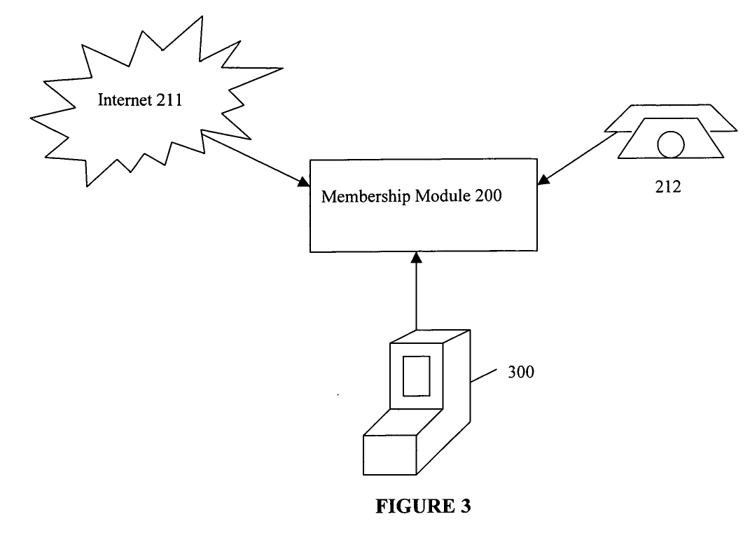

Participants to the product sampling system 120 first register with the product sampling system 120 via the membership module 200 as shown in detail in FIG. 2. As shown in FIG. 3, membership module 200 may be accessible via the Internet 211, a kiosk at an on-site location 300 or by telephone 212.

Each manufacturer 160 registers with the product sampling system 120 via the membership module 200 by providing basic information 125 such as contact information, etc. to set up an account in the manufacturer membership database 420. Once registered, the manufacturer 160 is given a username and password 170 to access selective databases 400.

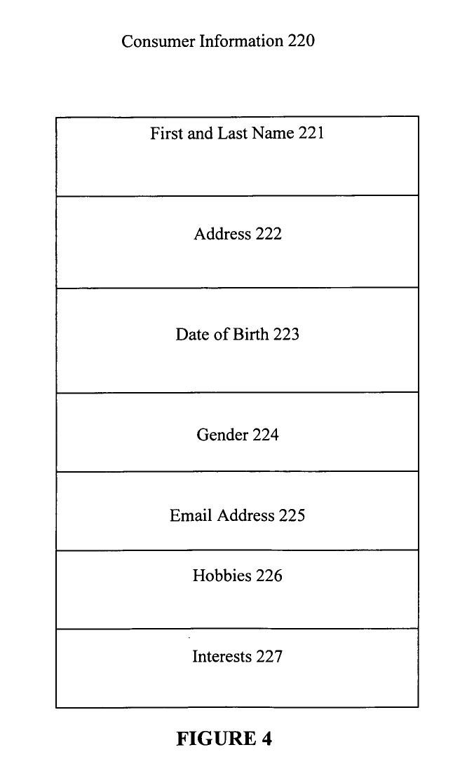

The consumers 140 also access the membership module 200 to register by providing the product sampling system 120 with his/her consumer information 220. As shown in FIG. 4, consumer information 220 includes, but is not limited to first and last name 221, address 222, date of birth 223, gender 224, e-mail address 225, hobbies 226, and interests 227, etc. As shown in FIG. 2, consumer information 220 is stored into a consumer membership database 410. Each consumer 140 is assigned an identification number 232 when he/she becomes a registered member 170.

A membership card 230 is provided to each registered consumer 140. The membership card 230 contains the unique identification number 232, which may be represented as a barcode, or in a magnetic strip that is used to identify the consumer 140 in the membership database 410. The identification number 232 links the consumer information 220 to a particular consumer 140. At the on-site locations 300, a membership card 230 may be provided for a nominal fee. The membership card may be a plastic key chain that can be easily carried around. A consumer 140 who registers on the Internet 211 can receive a printable membership card 230 without a fee. If a consumer 140 does not use his/her membership card 230 for a period of time, it will be deactivated and the consumer information 220 will be deleted from the membership database 410.

The on-site locations 300 of the product sampling system 120 are chosen to be the highest-pedestrian traffic areas to allow for maximum distribution, advertisement and exposure of products. The onsite location 300 may be a mall, airport, mass transit hub, sports stadium, casino, etc. Each onsite location 300 is linked to the database 400 to allow the information to be stored in a central location and still allow for data organization at each onsite location 300.

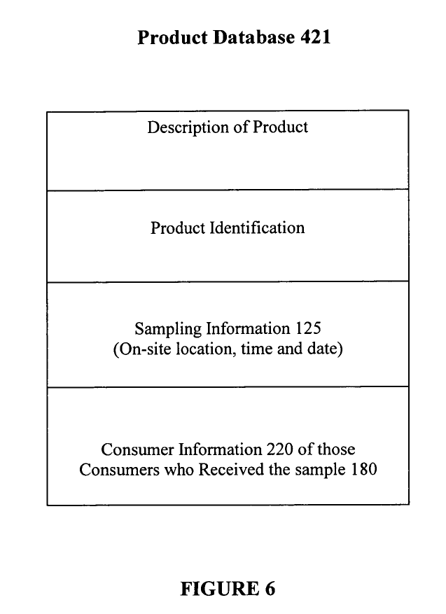

A manufacturer 160 that has new products that have not been placed on the market yet can advantageously utilize the product sampling system 120. Each product the manufacturer 160 wants to distribute via the product sampling system 120 must first be recorded with the database 400 with at least a description of the product. Each product is assigned a unique identification number. The product information is stored in a product database 421 (See FIG. 6) and is associated with the particular manufacturer 160 in the manufacturer membership database. Manufacturers 160 may provide samples 180 and print media 179 of products they would like to launch or test market to the product sampling system 120. The product sampling system 120 distributes the samples 180 to appropriate and/or selected on-site location 300 as requested by the manufacturer 160 or as chosen by the product sampling system 120.

The onsite location 300 may be a storefront, an Internet website, or a kiosk. At the onsite location 300, kiosks are present and free samples 180 are displayed. The kiosk may have an octagon formation, to facilitate the display of eight (8) samples 180. Each display center has information and print media 179 of the sample 180 provided by the manufacturer 160.

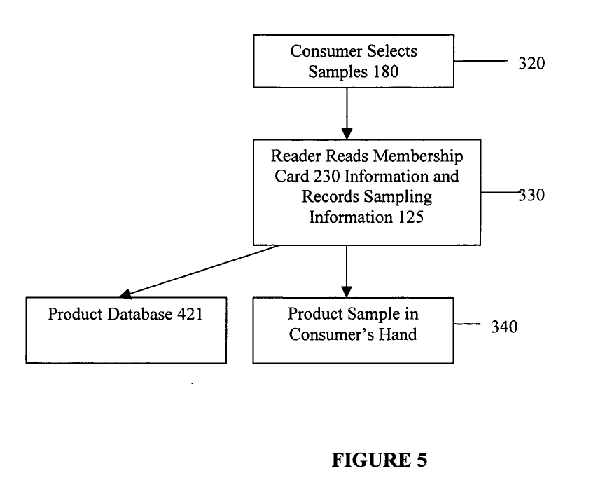

A consumer 140 can view the sample 180 being distributed and read the print media 179 pertaining to that product. A consumer 140 is encouraged to walk around the eight (8) kiosks and view each sample 180 being offered. As shown in FIG. 5, a consumer 140 may obtain a sample 180 by first selecting one or more samples to try 320. If the consumer 140 chooses to try a sample 180, a reader associated with a particular sample 180 at the kiosk reads 330 his/her membership card 230. At an eight-kiosk setup at the on-site location 300 there can be one single reader with the consumer selecting which particular sample(s) to try. There can also be a reader for each kiosk or each sample product offered.

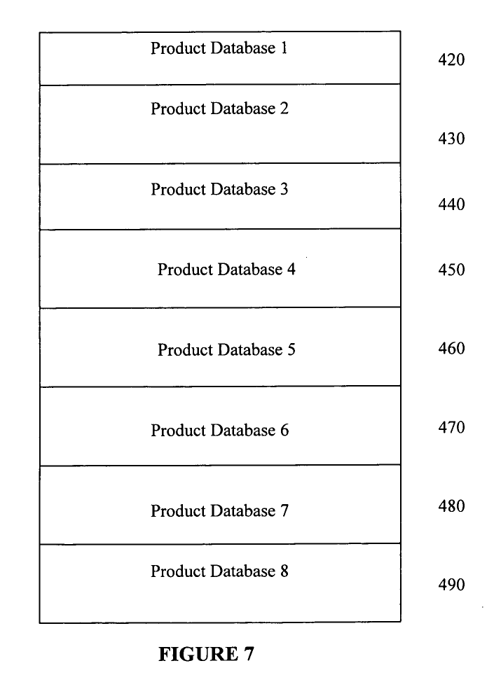

When the reader reads a membership card 230, a sample 180 is provided to the consumer 140. The consumer information 220 then becomes associated with the sampled product 180 and such consumer information 220 is stored in the product database 421 associated with the manufacturer 160 (see FIG. 6). Each sample 180 that is displayed at the onsite location 300 has its own product database 421 (see FIG. 7). For example, if eight (8) samples 180 are available at the onsite location 300, eight (8) product databases (420, 430, 440, 450, 460, 470, 480, 490) are set up in the database system 400. The time, date and location of the onsite location 300 of the sampling by a particular consumer 140 are stored into the product database 421 along with the particular consumer information 220 (see FIG. 6). By linking each consumer 140 who sampled a particular product 180, the product sampling system 120 can permit a consumer 140 to try only a certain number, e.g. one (1), of each sample 180 within a certain period of time.

The method of the present invention allows selective product databases 421 to be accessible by manufacturers 160. Manufacturers 160 can access their product database(s) (420, 430, 440, 450, 460, 470, 480, 490) through the product sampling system 120 via its website, mail or telephone, twenty-four (24) hours a day. Manufacturers 160 gain access to the relevant product database 421 with their user identification and password 170 provided at registration. Manufacturers 160 can view consumer information 220 and product sampling information 125 pertaining to each onsite location 300. Each product database 421 allows the information to be viewed by onsite location 300, product sampling information 125, consumer information 220, such as date of birth 223, gender 224, address 222, etc. Manufacturers 160 will be able to print reports in various layouts. Notifications may be sent to manufacturers 160 regarding the sampling of the samples 180 provided. A notification may be sent out to manufacturers 160 when the samples 180 provided are in low supply or have all been depleted at a particular on-site location 300, so that a manufacturer 160 can replenish the supplies as necessary. Manufacturers 160 are given access to the product databases 421 pertaining to their specific product samples 180, and will not be able to access the product databases 421 pertaining to other product samples 180 or other manufacturers 160.

Manufacturer's 160 access to the database 400 regarding their sample product 180 is advantageous for marketing and/or research purposes. Manufacturers 160 can access the consumer information 220 regarding consumers 140 who actually sampled their product. Manufacturers 160 can contact the consumer by telephone, mail or e-mail listed in the consumer information 220 for feedback on the sampled product. The manufacturers 160 can also send more samples to the consumers 140 who previously sampled their product, send coupons for their products, and/or send out surveys regarding the products sampled 180 at the onsite locations 300.

The features of the invention illustrated and described herein are the preferred embodiments. Therefore, it is understood that the appended claims are intended to cover unforeseeable embodiments with insubstantial differences that are within the spirit of the claims.

1. A system for distributing at least one product sample from at least one manufacturer to at least one consumer and for each said manufacturer receiving sampling information of each said consumer who received said product sample, comprising:
a. a consumer interface for receiving personal information from each said consumer;
b. a manufacturer interface for receiving contact information and product sample information from each said manufacturer;
c. at least one membership database storing said personal information of said consumer and said contact information and said product sample information of said manufacturer;
d. at least one distribution interface for distributing said product sample selected by said consumer and for recording sampling information;
e. at least one product database storing said sampling information of each said product sample and said personal information of each said consumer who sampled each said product sample; and
f. a reporting interface for access by said respective manufacturer based on said contact information and said product sample information to produce reports using information from said product database.

2. The system of claim 1 wherein said consumer interface comprises a kiosk.

3. The system of claim 1 wherein said consumer interface comprises the World Wide Web.

4. The system of claim 1 wherein said consumer interface comprises a telephone system.

5. The system of claim 1 wherein said consumer interface comprises an electronic network.

6. The system of claim 1 wherein said personal information comprises:
a. name;
b. address;
c. date of birth;
d. gender; and
e. email address.

7. The system of claim 1 wherein said manufacturer interface comprises an electronic network.

8. The system of claim 1 wherein said manufacturer interface comprises the World Wide Web.

9. The system of claim 1 wherein said manufacturer interface comprises a telephone system.

10. The system of claim 1 wherein said distribution interface comprises at least one distribution kiosk with each distribution kiosk displaying each said product sample.

11. The system of claim 1 wherein said distribution interface comprises an electronic network.

12. The system of claim 1 wherein said distribution interface comprises a commercial retail store.

13. The system of claim 1 wherein said product sample information comprises:
a. product name; and
b. product identification number.

14. The system of claim 1 wherein said sampling information comprises:
a. product identification number;
b. location of said distribution interface where said product sample was selected by said consumer; and
c. time said product sample was selected by said consumer.

15. The system of claim 1 wherein each said product sample has a corresponding product database for storing said sampling information of each said consumer who sampled each said product sample.

16. The system of claim 1 wherein said reporting interface comprises an electronic network.

17. The system of claim 1 wherein said reporting interface comprises the World Wide Web.

18. The system of claim 1 wherein said reporting interface comprises a telephone system.

19. A method for distributing at least one product sample from at least one manufacturer to at least one consumer and for each said manufacturer accessing sampling information of each said consumer who received said product sample, comprising the steps of:
a. receiving personal information from each said consumer;
b. receiving contact information and product sample information from each said manufacturer;
c. storing said personal information of said consumer and said contact information and said product sample information of said manufacturer in at least one membership database;
d. distributing said product sample to said consumer as selected by said consumer;
e. recording said sampling information of said product sample received by each said consumer;
f. storing said sampling information of said product sample and said personal information of each said consumer who sampled each said product sample in at least one product database; and
g. accessing information based on said contact information and said product sample information using said sampling information and said personal information from said product database.

20. The method of claim 19 wherein said personal information comprises:
a. name;
b. address;
c. date of birth;
d. gender; and
e. email address.

21. The method of claim 19 wherein said contact information comprises:
a. name;
b. address; and
c. email address.

22. The method of claim 19 wherein said product sample information comprises:
a. product name; and
b. product identification number.

23. The method of claim 19 wherein said product sample is distributed via ordinary mail.

24. The method of claim 19 wherein said product sample is distributed via a commercial retail store.

25. The method of claim 19 wherein said product sample is distributed via at least one kiosk.

26. The method of claim 25 wherein each of said kiosk displays each of said product sample.

27. The method of claim 19 further comprising the steps of:
a. distributing an identification card to each said consumer after receiving said personal information from said consumer;
b. associating said identification card with said personal information of said consumer; and
c. reading said identification card of each said consumer who selected to receive said product sample.

28. The method of claim 25 further comprising the steps of:
a. distributing an identification card to each said consumer after receiving said personal information from said consumer;
b. associating said identification card with said personal information of said consumer;
c. providing at least one reader at said kiosk for reading said identification card;
d. reading said identification card of each said consumer who selected to receive said product sample before distributing said product sample to said consumer; and
e. storing said sampling information and personal information of each said consumer associated with said identification card in said product database.

29. The method of claim 19 wherein said sampling information comprises:
a. product identification number;
b. location of said distribution interface where said product sample was selected by said consumer; and
c. time said product sample was selected by said consumer.

30. The method of claim 19 wherein each said product sample has a corresponding product database for storing said sampling information of each said consumer who sampled each said product sample.

31. The method of claim 19 wherein said information is accessed via an electronic network.

32. The method of claim 19 wherein said information is accessed via the World Wide Web.

33. The method of claim 19 wherein said information is accessed via a telephone system.

34. The method of claim 18 further comprising the step of:
producing reports based on said contact information and said product sample information using said sampling information and said personal information from said product database.
